(19) United States
(12) Patent Application Publication
(10) Pub. No.: US 2016/0091623 A1
(43) Pub. Date: Mar. 31, 2016

(54) Method and Device for Estimating Quality Factor Based on Zero Offset Vertical Seismic Profile Data

(71) Applicant: PetroChina Company Limited, Beijing (CN)

(72) Inventors: Yongcai Yu, Beijing (CN); Xiping Sun, Beijing (CN); Ming Zhang, Beijing (CN); Xingfu Cui, Beijing (CN); Lianhua Hou, Beijing (CN)

(21) Appl. No.: 14/919,053

(22) Filed: Oct. 21, 2015

Related U.S. Application Data
(63) Continuation of application No. PCT/CN2013/090914, filed on Dec. 30, 2013.

(51) Int. Cl. G01V 1/30; G01V 1/40

(52) U.S. Cl. CPC G01V 1/307; G01V 1/40; G01V 2210/161

(57) ABSTRACT

This disclosure provides a method and a device for estimating a quality factor based on zero offset VSP (Vertical Seismic Profiling) data, wherein the method includes the following steps: determining a transmission coefficient between two adjacent VSP channels based on an interval velocity of a seismic wave in the zero offset VSP data; and determining the transmission coefficient as an indeterminate coefficient in an objective function of an index method, and estimating the quality factor according to the objective function of the index method.

### CROSS-REFERENCE TO RELATED APPLICATIONS

This application is a continuation of International Application No. PCT/CN2013/090914 filed on Dec. 30, 2013, which is hereby incorporated by reference in its entirety.

### TECHNICAL FIELD

This disclosure relates to the technical field of physical exploration, and more particularly, to a method and a device for estimating a quality factor based on zero offset VSP (Vertical Seismic Profiling) data.

### BACKGROUND

When the seismic waves propagate in the earth medium, absorption caused by medium viscosity can cause energy attenuation and velocity dispersion for seismic waves since the earth medium is not perfectly elastic. Such attenuation characteristics inherent in a medium are generally described by a quality factor Q. Due to the existence of the quality factor, attenuation of high-frequency energy for seismic wave is stronger than that of the low-frequency energy, and propagation velocity of high-frequency components is faster than that of low-frequency components, and meanwhile it may further cause energy weaker and frequency band narrower in the seismic profile deep-layer, thereby resulting in a lower resolution of data and increasing the difficulty of fine interpretation of seismic data.

With respect to the above problem, an inverse Q filtering is an effective means for compensating for absorption attenuation of the seismic data, which can compensate and correct energy attenuation and velocity dispersion during the seismic wave propagation, thereby improving data resolution.

An accurate estimation of quality factors is the premise of performing the inverse Q filtering, as compared to surface seismic data, vertical seismic profiling (VSP) data is widely applied to quality factor estimation since it is subjected to less interference. After a comparison study was previously conducted for a time domain method (such as an amplitude attenuation method, a rise time method, a wavelet simulation method, an analytic signal method and the like) and a frequency domain method (such as a matching method, a spectrum simulation method, a spectral ratio method and the like), using the VSP data, it is found that there is no method that applies to any situation, and it depends on the quality of the data that how well the effect produced by each method is. Currently, there is a centroid frequency shift method, which mainly utilizes a change in centroid frequency during seismic wave propagation to obtain a quality factor. In the abovementioned methods, the spectral ratio method is a common method for estimating the quality factor, and the quality factor is estimated by utilizing a linear relation between the spectrum ratio logarithm and the frequency, however, the slope fitting thereof is easily affected by the spectrum ratio logarithm error, which leads to the stability of estimating the quality factor being affected. The index method effectively avoids drawbacks caused by existence of the spectrum ratio logarithm, and the index method estimates the quality factor by using a forward matching approach, and is capable of effectively improving the stability of estimating the quality factor. However, it is found in the practical operation that relatively large errors may often occur on the quality factor estimated by the index method, and the accuracy of estimating the quality factor is difficult to be guaranteed.

### SUMMARY

The embodiments of the present invention provide a method for estimating a quality factor based on zero offset VSP data, including:

determining a transmission coefficient between two adjacent VSP channels based on an interval velocity of a seismic wave in the zero offset VSP data; and

determining the transmission coefficient as an indeterminate coefficient in an index method objective function, and estimating the quality factor according to the objective function of the index method.

The embodiments of the present invention provide a device for estimating a quality factor based on zero offset VSP (Vertical Seismic Profiling) data, comprising a processor configured to:

determine a transmission coefficient between two adjacent VSP channels based on an interval velocity of a seismic wave in the zero offset VSP data; and

determine the transmission coefficient as an indeterminate coefficient in an objective function of an index method, and estimate the quality factor according to the objective function of the index method.

### BRIEF DESCRIPTION OF THE DRAWINGS

The accompanying drawings described herein are used to provide a further understanding of the present invention and constitute a part of this application, but are not construed as limitations to the present invention. In the drawings:

FIG. 1 is a flow diagram of a method of estimating a quality factor based on zero offset VSP data according to an embodiment of the present invention;

FIG. 2 is a structural block diagram of a device of estimating a quality factor based on the zero offset VSP data according to an embodiment of the present invention;

FIG. 3 is a schematic diagram of a zero offset displacement VSP observing system according to an embodiment of the present invention;

FIG. 4 is a schematic diagram of attenuation VSP direct wave first arrival record according to an embodiment of the present invention;

FIG. 5 is a schematic diagram of a result of estimating a quality factor by a noise-free data index method according to an embodiment of the present invention;

FIG. 6 is a schematic diagram of a result of estimating a quality factor by a noise data index method according to an embodiment of the present invention;

FIG. 7 is a schematic diagram of matching errors of the index method corresponding to different quality factors for the noise-free data according to an embodiment of the present invention;

FIG. 8 is a schematic diagram of a coefficient Cₖ of the index method corresponding to different quality factors for the noise-free data according to an embodiment of the present invention;

FIG. 9 is a schematic diagram of matching errors of the index method corresponding to different quality factors for the noise data according to an embodiment of the present invention;

FIG. 10 is a schematic diagram of a coefficient Cₖ of the index method corresponding to different quality factors for the noise-free data according to an embodiment of the present invention;

FIG. 11 is a schematic diagram of a result of estimating the quality factor by the index method in the case where a coefficient Cₖ=1 is set according to an embodiment of the present invention;

FIG. 12 is a schematic diagram of a stability analysis of the index method when the coefficient Cₖ for the noise-free data is known according to an embodiment of the present invention;

FIG. 13 is a schematic diagram of a stability analysis of the index method when the coefficient Cₖ for the noise data is known according to an embodiment of the present invention;

FIG. 14 is a schematic diagram of a velocity model and a quality factor model according to an embodiment of the present invention;

FIG. 15 is a schematic diagram of a result of estimating the quality factor by the spectral ratio method, the index method and the improved index method for the noise-free data according to an embodiment of the present invention;

FIG. 16 is a schematic diagram of a result of estimating the quality factor by the spectral ratio method for the noise data according to an embodiment of the present invention;

FIG. 17 is a schematic diagram of a result of estimating the quality factor by the index method for the noise data according to an embodiment of the present invention;

FIG. 18 is a schematic diagram of a result of estimating the quality factor by the improved index method for the noise data according to an embodiment of the present invention.

### DETAILED DESCRIPTION

The inventors have found, after conducting a study on the index method, that the reason that a deviation of accuracy of the quality factor estimated by the index method occurs is that there exists an indeterminate coefficient in the index method and the presence of the indeterminate coefficient affects exertion of the performance of the index method. Accordingly, the inventors have found, after the study, that the indeterminate coefficient in the index method can be firstly obtained, and then the quality factor is estimated, thereby eliminating the effects of the indeterminate coefficient on the stability and accuracy of the method, and the stability of estimating the quality factor can be further improved in such a manner in which the quality factor is estimated.

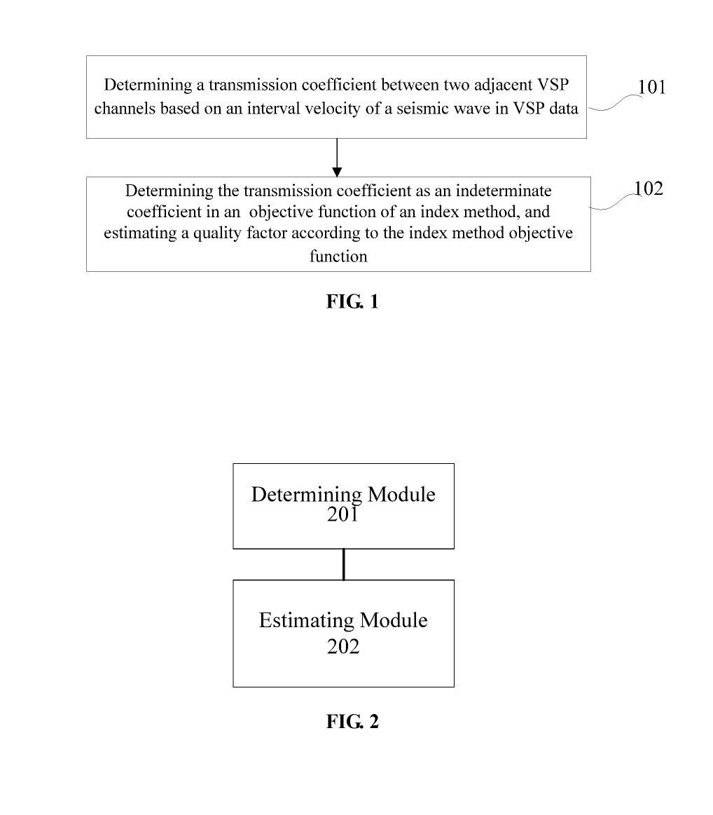

In the embodiment of the present invention, a method for estimating a quality factor based on zero offset VSP data, as shown in FIG. 1, is set forth, and the method includes the following steps of:

Step 101: determining a transmission coefficient between two adjacent VSP channels based on an interval velocity of a seismic wave in VSP data;

Step 102: determining the transmission coefficient as an indeterminate coefficient in an objective function of an index method, and estimating the quality factor according to the objective function of the index method.

In the above embodiment, the transmission coefficient between the two VSP channels is determined by the interval velocity of the seismic wave, and then the transmission coefficient is determined as an indeterminate coefficient in the objective function of the index method, and the quality factor is estimated according to the objective function of the index method, thereby solving the technical problem of lower stability and accuracy of estimating the quality factor due to the existence of the indeterminate coefficient in the process of estimating the quality factor by adopting the index method in the prior art, and achieving the technical effect of improving stability and accuracy of estimating the quality factor.

Specifically, the determination of the transmission coefficient in the above step 101 can be implemented by the following formula:

$${P}_{k} = 1 + \frac{{v}_{k} - {v}_{k - 1}}{{v}_{k} + {v}_{k - 1}}$$

Where Pₖ represents the transmission coefficient, vₖ represents an interval velocity between (k-1)^{th} and k^{th} VSP channels, and vₖ₋₁ represents an interval velocity between (k-2)^{th} and (k-1)^{th} VSP channels.

The reason why the transmission coefficient is taken as the indeterminate coefficient in the index method is mainly that: the indeterminate coefficient Cₖ generally includes two aspects: geometric diffusion effect Gₖ during propagation and transmission loss Pₖ at a wave impedance interface. In which, an amplitude attenuation caused by the geometric diffusion effect can be compensated through a geometric diffusion correction, and thus the problem of obtaining the coefficient Cₖ is converted into how to solve the transmission loss Pₖ caused by the wave impedance interface.

After obtaining the transmission coefficient, the transmission coefficient can be substituted into the objective function of the index method to obtain the quality factor, that is, substituting the transmission coefficient as the indeterminate coefficient of the objective function into the objective function; acquiring, by way of scanning the quality factor, the quality factor, which allows the objective function to have a minimum matching error; and taking the quality factor corresponding to the objective function with the minimum matching error as the obtained quality factor.

The above objective function is

$$G ( {Q}_{k} , {C}_{k} ) = {\sum }_{f = {f}_{1}}^{{f}_{2}} {[ {S}_{k} ( f ) - {C}_{k} {S}_{k - 1} ( f ) exp ( \frac{- π {t}_{k}}{{Q}_{k}} f ) ]}^{2}$$

Where f₁ represents a lower frequency limit of a predominant frequency band, f₂ represents an upper frequency limit of the predominant frequency band, Sₖ(f) represents an amplitude spectrum of a seismic wave of k^{th} VSP channel, Sₖ₋₁(f) represents an amplitude spectrum of a seismic wave of (k-1)^{th} VSP channel, tₖ represents a propagation time of a seismic wave between k^{th} and (k-1)^{th} VSP channels, Cₖ represents the indeterminate coefficient, Qₖ represents the quality factor between (k-1)^{th} and k^{th} VSP channels, and G represents a matching error.

In each of the abovementioned embodiments, in the step 101 as mentioned above, the step of determining a transmission coefficient between two adjacent VSP channels based on the interval velocity of the seismic wave in the zero offset VSP data, includes: performing a geometric diffusion compensation and a wave field separation for the zero offset VSP data to obtain a down-going wave field; and determining the transmission coefficient between the two adjacent VSP channels according to the interval velocity of the seismic wave in the down-going wave field. That is, the data input of the method for estimating a quality factor based on the zero offset VSP data is the down-going wave field of the zero offset VSP data that is subjected to the geometric diffusion compensation.

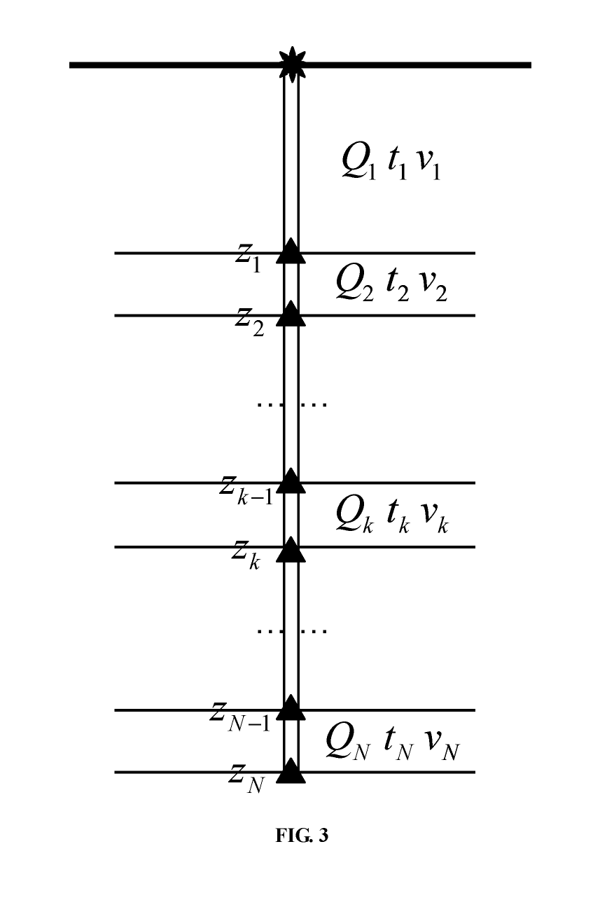

Based on the same inventive concept, the embodiment of the present invention further provides a device for estimating a quality factor based on zero offset VSP data, as described in the embodiment below. Since the principle that the device for estimating a quality factor based on zero offset VSP data solves the problem is similar to the method for estimating a quality factor based on zero offset VSP data, an implementation of the device for estimating the quality factor based on the zero offset VSP data may refer to that of the method for estimating the quality factor based on the zero offset VSP data, and thus repetitious descriptions will be omitted. The term “unit” or “module” as used below can be a combination of software and/or hardware that implements prescribed functions. Although the device described in the following embodiments is preferably implemented in software, an implementation thereof in hardware, or a combination of software and hardware is also possible and conceived. FIG. 2 is a structural block diagram of a device of estimating a quality factor based on the zero offset VSP data according to an embodiment of the present invention. As shown in FIG. 2, the device includes: a determining module 201 and an estimating module 202, the structure will be described below. The determining module 201 is configured to determine a transmission coefficient between two adjacent VSP channels based on the interval velocity of the seismic wave in the zero offset VSP data.

The estimating module 202 is configured to determine the transmission coefficient as an indeterminate coefficient in an objective function of an index method, and estimate the quality factor according to the objective function of the index method.

In one embodiment, the determining module 201 is specifically configured to determine the transmission coefficient according to the following formula:

$${P}_{k} = 1 + \frac{{v}_{k} - {v}_{k - 1}}{{v}_{k} + {v}_{k - 1}}$$

Where Pₖ represents the transmission coefficient, vₖ represents an interval velocity between (k-1)^{th} and k^{th} VSP channels, and vₖ₋₁ represents an interval velocity between (k-2)^{th} and (k-1)^{th} VSP channels.

In one embodiment, the estimating module 202 includes:

a determining unit configured to determine a value range of the quality factor;

a scanning unit configured to acquire, by way of scanning the quality factor within the value range, the quality factor which allows the objective function to have the minimum matching error; and

an estimating unit configured to take the quality factor corresponding to the objective function with the minimum matching error as an estimated quality factor.

In one embodiment, the objective function is:

$$G ( {Q}_{k} , {C}_{k} ) = {\sum }_{f = {f}_{1}}^{{f}_{2}} {[ {S}_{k} ( f ) - {C}_{k} {S}_{k - 1} ( f ) exp ( \frac{- π {t}_{k}}{{Q}_{k}} f ) ]}^{2}$$

Where f₁ represents a lower frequency limit of a predominant frequency band, f₂ represents an upper frequency limit of a predominant frequency band, Sₖ(f) represents an amplitude spectrum of a seismic wave of k^{th} VSP channel, Sₖ₋₁(f) represents an amplitude spectrum of a seismic wave of (k-1)^{th} VSP channel, tₖ represents a propagation time of a seismic wave between k^{th} and (k-1)^{th} VSP channels, Cₖ represents the indeterminate coefficient, Qₖ represents the quality factor between (k-1)^{th} and k^{th} VSP channels, and G represents a matching error.

In one embodiment, the determining module 201 includes: a wave field separation unit configured to perform a geometric diffusion compensation and a wave field separation for the zero offset VSP data to obtain a down-going wave field; and a transmission coefficient determining unit configured to determine the transmission coefficient between the two adjacent VSP channels according to the interval velocity of the seismic wave in the down-going wave field.

The present invention further provides a specific embodiment for a detailed description of the above method for estimating a quality factor based on zero offset VSP data. However, it is noted that the specific embodiment is provided merely for a better illustration of the present invention, but is not to be construed as improper limitations to the present invention.

Considering the Earth's absorption and attenuation effect, the amplitude spectrum of the seismic wavelets during propagation can be expressed as:

$${S}_{k} ( f ) = {C}_{k} \cdot {S}_{k - 1} ( f ) exp ( \frac{- π {t}_{k}}{{Q}_{k}} f ) \qquad ( Formula 1 )$$

Where f₁ represents a frequency, and Sₖ(f) and Sₖ₋₁(f) respectively represents an amplitude spectrum of seismic waves where depth of detection points as shown in FIG. 3 is zₖ and zₖ₋₁, tₖrepresents a propagation time of the seismic waves between two detection points zₖ and zₖ₋₁, the coefficient Cₖ represents a number independent of the frequency, Qₖ represents an interlayer quality factor, it is generally assumed that it does not depend on the frequency. It is noted that the k herein represents the detection point number in the process of collecting data, and represents a channel number of VSP channels in the process of calculating the quality factor, both are essentially the same.

Based on the above formula 1, the spectral ratio method is the most commonly used method for estimating a quality factor, and this method estimates the quality factor by utilizing a linear relation between the spectrum ratio logarithm and the frequency of seismic wavelets at two different times. However, the spectrum ratio logarithm is easily affected by amplitude spectrum frequency notch and noise, which results in an oscillation that occurs on a linear relation between it and the frequency, thereby affecting the stability of estimating the quality factor. Therefore, an index method was previously proposed, which obtains an interlayer quality factor using a forward matching approach by solving the minimal value of the following equation:

$$G ( {Q}_{k} , {C}_{k} ) = {\sum }_{f = {f}_{1}}^{{f}_{2}} {[ {S}_{k} ( f ) - {C}_{k} \cdot {S}_{k - 1} ( f ) exp ( \frac{- π {t}_{k}}{{Q}_{k}} f ) ]}^{2} \qquad ( Formula 2 )$$

Where f₁ and f₂ represent a lower frequency limit and an upper frequency limit, respectively, and in order to eliminate the indeterminate Cₖ in the above formula 2, a derivation approach can be used such that ∂G/∂Cₖ=0, thereby obtaining:

$${C}_{k} ( {Q}_{k} ) = \frac{{\sum }_{f = {f}_{1}}^{{f}_{2}} {S}_{k} ( f ) {S}_{k - 1} ( f ) exp ( \frac{- π {t}_{k}}{{Q}_{k}} f )}{{\sum }_{f = {f}_{1}}^{{f}_{2}} {S}_{k - 1}^{2} ( f ) exp ( \frac{- 2 π {t}_{k}}{{Q}_{k}} f )} \qquad ( Formula 3 )$$

Formula 3 is substituted into formula 2, then the formula 2 merely contains one indeterminate coefficient, such that Qₖ , which allows the formula 2 to have the minimum value, can be obtained by way of scanning the quality factor.

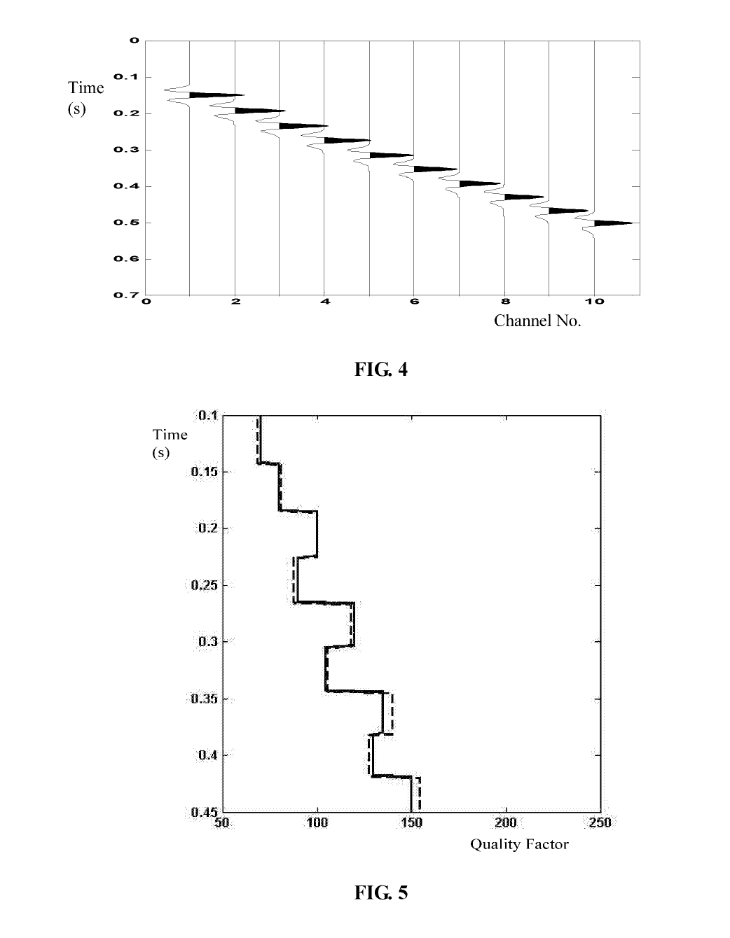

In order to verify the performance of the quality factor estimation method, a forward modeling approach can be used to obtain attenuation VSP records as shown in FIG. 4, in order to eliminate the effects of other factors as much as possible, a first-arrival wave field of a down-going direct wave is only simulated in FIG. 4, and a change in wavelet waveform at adjacent channels is only caused by the interlayer quality factor.

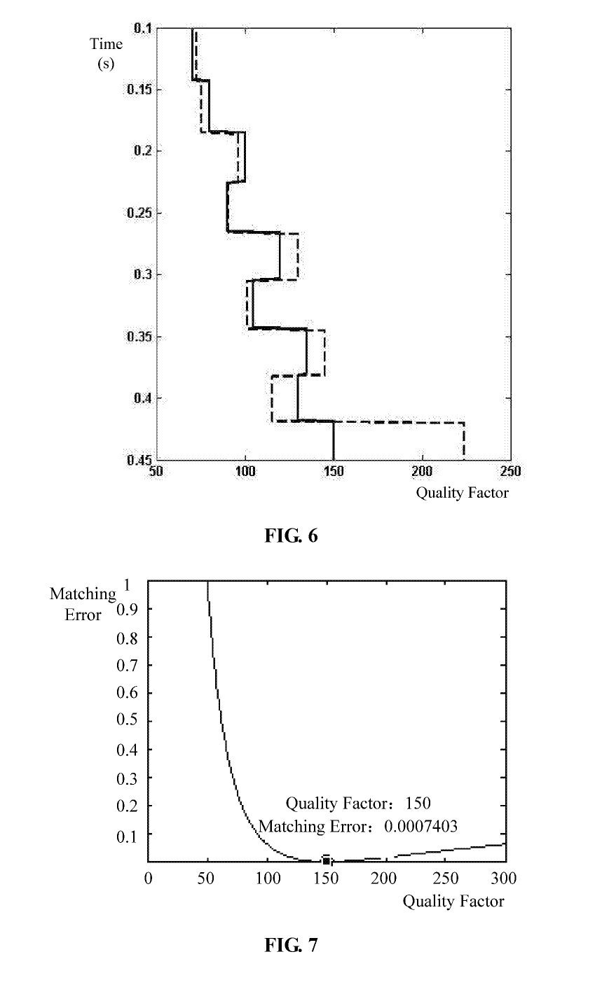

With respect to forward modeling records as shown in FIG. 4, weak random noise (wherein noise energy accounts for 0.3% of effective signal energy) is introduced, an estimation of the quality factor of noise-free data and noise data is performed by the index method, respectively. The estimated results are as shown in FIGS. 5 and 6. As can be seen from the estimated results, when noise is not contained in the data, the quality factor estimation results coincide quite well with the theoretical values (as shown in FIG. 5), when noise is contained, there is a deviation between the quality factor estimation results and theoretically true values (as shown in FIG. 6), wherein in FIGS. 5 and 6, the solid line represents a theoretical value, and the dotted line represents the quality factor estimation results.

As can be seen from FIG. 6, the quality factor estimation result of noise data between 9^{th} and 10^{th} channel in FIG. 4 is 206, and relative to the true value 150, the absolute error of the estimation result is 56 and the relative error is 37.3%.

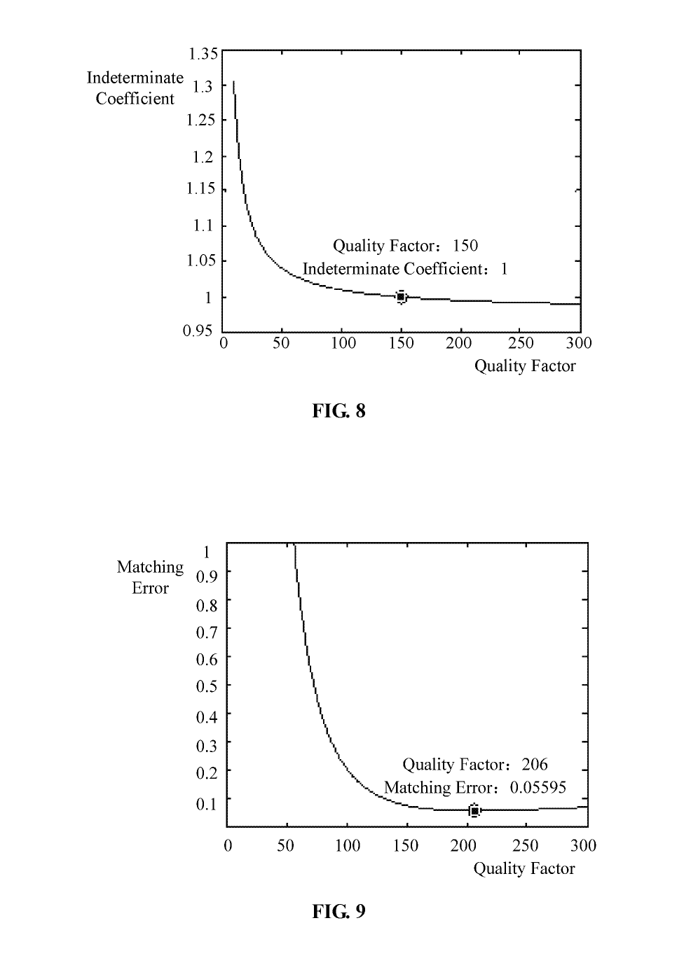

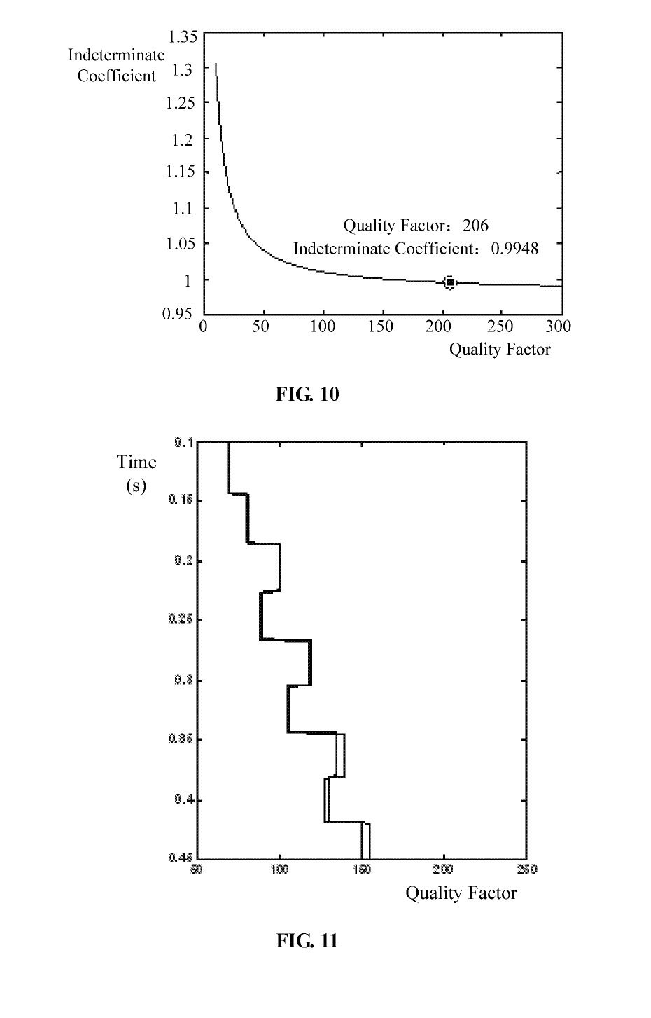

In order to analyze the causes of the error of the index method, a scanning range of the quality factor is set as 1 to 300, Cₖ in coefficient formula 3 and matching errors in formula 2 are calculated, respectively. In the absence of noise, the quality factor corresponding to the minimum matching error is 150 as shown in FIG. 7, in this case, the coefficient Cₖ corresponding to the quality factor is 1 as shown in FIG. 8, which is fully consistent with the true value. However, in the case of noise, the quality factor corresponding to the minimum matching error is 206 as shown in FIG. 9, in this case, the coefficient Cₖ corresponding to the quality factor is 0.9948 as shown in FIG. 10, which are both deviated from the true value.

In order to further observe its stability, a scanning range of Qₖ is set as 1 to 300, and a scanning range of the coefficient Cₖ is set as 0.8 to 1.35, matching error distribution diagrams of the noise-free data and the noise data are obtained, respectively, and it is obtained by analyzing that in the vicinity of the true value (i.e., Qₖ=150, Cₖ=1), the matching error is located in the bottom, and the trend is very gentle, and this causes that if there exists a little noise in the original data, the minimum matching error (0.05595) may deviate from the true minimum matching error (0.0007557), thereby causing the estimation result of the quality factor (Qₖ=206) to deviate from the true value. In the case of noise, Cₖ becomes 0.9948, and for the forward record as shown in FIG. 4, the actual theoretical value should be 1, and thus, the indeterminate coefficient Cₖ in the above formula 3 is one reason that makes the method unstable, and for the noise data, if Cₖ is set to 1, the results after calculating the quality factor by re-utilizing the index method are shown in FIG. 11, it can be found that the goodness of fit between the quality factor estimation result and the theoretical value is significantly improved.

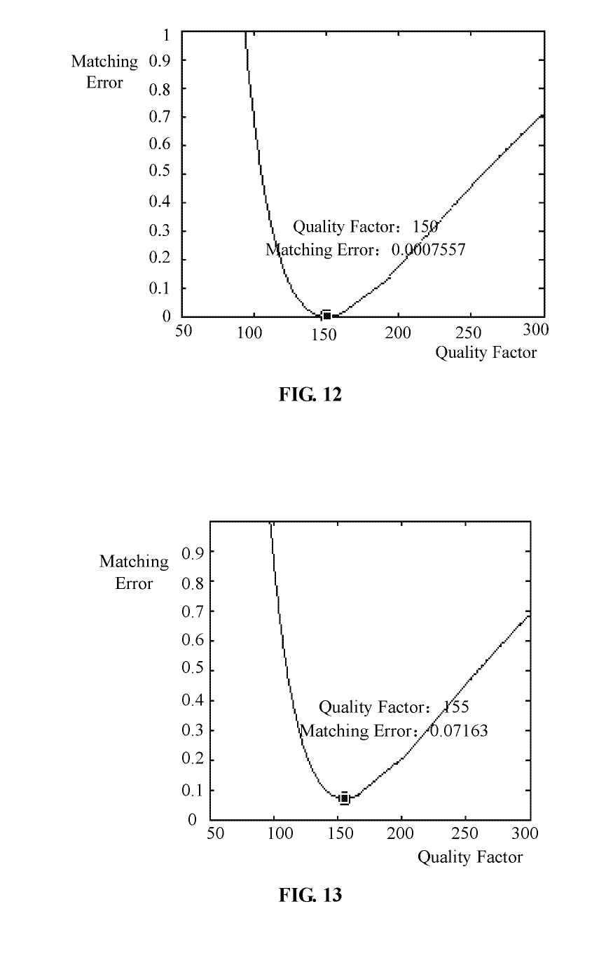

Also, for data between 9^{th} and 10^{th} channel in FIG. 4, a stability analysis is conducted for the index method on the premise that the coefficient Cₖ is a known theoretical value. For the noise-free data and the noise data, a scanning range of the quality factor is set as 1 to 300, the corresponding matching errors are calculated, as shown in FIGS. 12 and 13. It can be seen that the minimum value is obviously located at a trough in the curve, as compared with FIGS. 7 and 9, in the case of noise effects, in FIG. 13, the quality factor estimation result changes from 150 to 155, and the stability is significantly improved.

Thus, based on the above analysis, if the coefficient Cₖ can be obtained, and then the accuracy of estimating the quality factor by the formula 2 can be further improved, and it is analyzed below how to obtain the coefficient Cₖ.

For first arrival of direct wave of the zero offset VSP data at adjacent channels, the coefficient Cₖ thereof generally includes two aspects: a geometric diffusion effect Gₖ during propagation and transmission loss Pₖ at a wave impedance interface. In which, an amplitude attenuation caused by the geometric diffusion effect can be compensated through a geometric diffusion correction, thus the problem of obtaining the coefficient Cₖ is converted into how to solve the transmission loss Pₖ caused by the wave impedance interface. For zero offset VSP data, in accordance with an arrival time of each channel direct wave and a depth of the detection points, an average velocity from the surface to the detection points can be obtained, and then it is converted into an interval velocity, such that a transmission coefficient between two adjacent channels can be obtained, that is,

$${P}_{k} = 1 + \frac{{v}_{k} - {v}_{k - 1}}{{v}_{k} + {v}_{k - 1}} \qquad ( Formula 4 )$$

Introducing Pₖ to the above formula 2, as can be obtained:

$$G ( {Q}_{k} ) = {\sum }_{f = {f}_{1}}^{{f}_{2}} {[ {S}_{k} ( f ) - ( 1 + \frac{{v}_{k} - {v}_{k - 1}}{{v}_{k} + {v}_{k - 1}} ) {S}_{k - 1} ( f ) exp ( \frac{- π {t}_{k}}{{Q}_{k}} f ) ]}^{2} \qquad ( Formula 5 )$$

The above formula 5 is an objective function of the improved index method, the Q value corresponding to the minimum matching error obtained by way of Q scanning serves as an obtained interlayer quality factor.

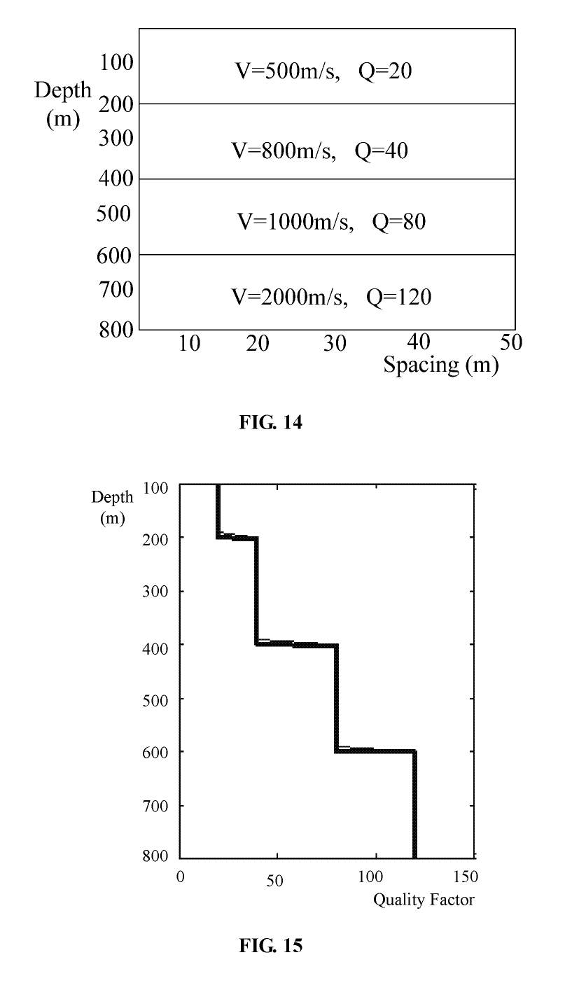

In order to test the feasibility of the method, the velocity model and the quality factor model as shown in FIG. 14 are given, the seismic source is located at the surface, the depth of the receiving points is 100-800 m, and an interval of the receiving points is 10 m; and a zero offset VSP full wave field, a down-going wave field and an up-going wave field are obtained, respectively, by using the propagation matrix method including absorption attenuation effect for performing forward numerical simulation.

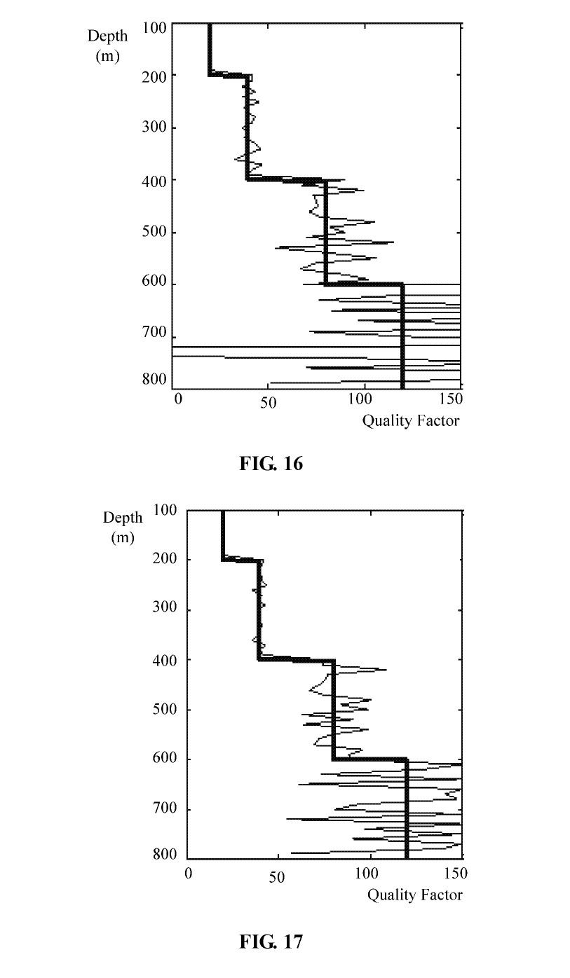

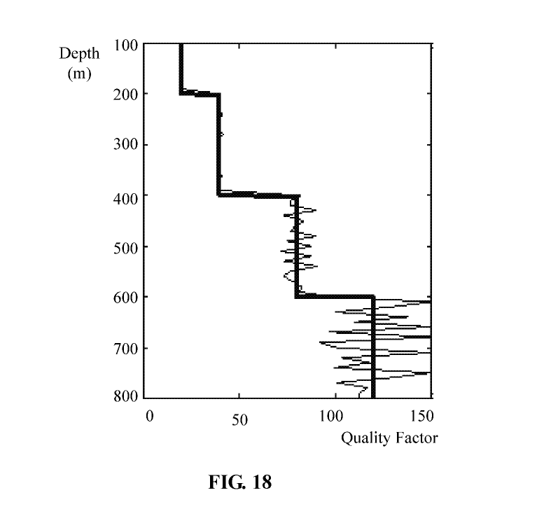

For the down-going wave field, random noise (wherein energy of noise accounts for 0.3 of the effective signal energy) is introduced, and the quality factors for the noise-free data and the noise data are calculated, respectively. It is found from the estimated results of the quality factors that for the noise-free data, as shown in FIG. 15, the estimation results of the spectrum ratio method, the index method and the estimation method in the present embodiment all coincide quite well with the true values. For the noise data, when the quality factor is relatively small (for example, 20 and 40), the estimation results of the three methods all coincide quite well with the true values, however, when the quality factor is relatively large (for example, 80 and 120), there exists estimation offsets to some extent in the three methods, the spectral ratio method, as shown in FIG. 16, has a large offset, especially when the quality factor is 120, the estimation result is difficult to be accepted; as to the index method, as shown in FIG. 17, the estimation result is highly improved relative to the spectrum ratio method; and the estimation method in the present embodiment, as shown in FIG. 18, further improves the estimation results of the quality factor. In the above-described FIG. 15 to FIG. 18, bold lines represent the true values and thin lines represent the estimation results.

The stability and accuracy of estimating the quality factor can be effectively improved by the aforementioned manner in which the quality factor is estimated.

In another embodiment, a software for performing the technical solutions described in the above embodiments and preferred embodiments are further provided. p In another embodiment, it is further provided a storage medium in which the above software is stored, and the storage medium includes but not limited to a compact disc, a floppy disk, a hard disk, an erasable memory and the like.

As can be seen from the above descriptions, the embodiments of the present invention achieve the following technical effects: a transmission coefficient between two VSP channels is determined through an interval velocity of a seismic wave, and then the transmission coefficient is determined as an indeterminate coefficient in an objective function of the index method, and the quality factor is estimated according to the objective function of the index method, thereby solving the technical problem of lower stability and accuracy of estimating the quality factor due to the existence of the indeterminate coefficient in the process of estimating the quality factor by adopting the index method in the prior art, and achieving the technical effect of improving stability and accuracy of estimating the quality factor.

Obviously, the persons skilled in the art should appreciate that the respective modules or steps in the abovementioned embodiments of the present invention can be implemented by using a general computing device, they can be focused on a single computing device or distributed on a network consisting of multiple computing devices, and alternatively, they can be implemented using a program code executable by a computing device, thus they can be stored in the storage device to be executed by the computing device, and, in some cases, the steps as illustrated or described may be executed in an order different from that described herein, or they can be fabricated as various integrated circuit module, respectively, or a plurality of modules or steps therein are fabricated as a single integrated circuit module. Thus, the embodiments of the present invention are not limited to any specific combination of hardware and software.

The above are just preferred embodiments of the present invention, and are not intended to limit the present invention. For persons skilled in the art, various modifications and changes can be made to the embodiments of the present invention. Any modification, equivalent replacement and improvement made within the spirit and principle of the present invention shall be covered in the protection scope of the present invention.

What is claimed is:

1. A method for estimating a quality factor based on zero offset Vertical Seismic Profiling (VSP) data, comprising:
determining a transmission coefficient between two adjacent VSP channels based on an interval velocity of a seismic wave in the zero offset VSP data; and
determining the transmission coefficient as an indeterminate coefficient in an objective function of an index method, and estimating the quality factor according to the objective function of the index method.

2. The method according to claim 1, wherein the step of determining the transmission coefficient between the two adjacent VSP channels based on the interval velocity of the seismic wave in the zero offset VSP data, comprises:
determining the transmission coefficient in accordance with a following formula:
$${P}_{k} = 1 + \frac{{v}_{k} - {v}_{k - 1}}{{v}_{k} + {v}_{k - 1}}$$
where Pₖ represents the transmission coefficient, vₖ represents an interval velocity between (k-1)^{th} and k^{th} VSP channels, and vₖ₋₁ represents an interval velocity between (k-2)^{th} and (k-1)^{th} VSP channels.

3. The method according to claim 1, wherein the step of determining the transmission coefficient as the indeterminate coefficient in the objective function of the index method, and estimating the quality factor according to the objective function of the index method, comprises:
determining a value range of the quality factor;
acquiring, by way of scanning the quality factor within the value range, the quality factor which allows the objective function to have a minimum matching error; and
taking the quality factor corresponding to the objective function with the minimum matching error as an estimated quality factor.

4. The method according to claim 1, wherein the objective function is:
$$G ( {Q}_{k} , {C}_{k} ) = {\sum }_{f = {f}_{1}}^{{f}_{2}} {[ {S}_{k} ( f ) - {C}_{k} {S}_{k - 1} ( f ) exp ( \frac{- π {t}_{k}}{{Q}_{k}} f ) ]}^{2}$$
where f₁ represents a lower frequency limit of a predominant frequency band, f₂ represents an upper frequency limit of the predominant frequency band, Sₖ(f) represents an amplitude spectrum of a seismic wave of k^{th} VSP channel, Sₖ₋₁(1) represents an amplitude spectrum of a seismic wave of (k-1)^{th} VSP channel, tₖ represents a propagation time of a seismic wave between k^{th} and (k-1)^{th} VSP channels, Cₖ represents the indeterminate coefficient, Qₖ represents the quality factor between (k-1)^{th} and k^{th} VSP channels, and G represents a matching error.

5. The method according to claim 1, wherein the step of determining the transmission coefficient between the two adjacent VSP channels based on the interval velocity of the seismic wave in the zero offset VSP data, comprises:
performing a geometric diffusion compensation and a wave field separation for the zero offset VSP data to obtain a down-going wave field; and
determining the transmission coefficient between the two adjacent VSP channels, according to the interval velocity of the seismic wave in the down-going wave field.

6. A device for estimating a quality factor based on zero offset Vertical Seismic Profiling (VSP) data comprising a processor configured to:
determine a transmission coefficient between two adjacent VSP channels based on an interval velocity of a seismic wave in the zero offset VSP data; and
determine the transmission coefficient as an indeterminate coefficient in an objective function of an index method, and estimate the quality factor according to the objective function of the index method.

7. The device according to claim 6, wherein the processor is further configured to determine the transmission coefficient according to the following formula:
$${P}_{k} = 1 + \frac{{v}_{k} - {v}_{k - 1}}{{v}_{k} + {v}_{k - 1}}$$
where Pₖ represents the transmission coefficient, vₖ represents an interval velocity between (k-1)^{th} and k^{th} VSP channels, and vₖ₋₁ represents an interval velocity between (k-2)^{th} and (k-1)^{th} VSP channels.

8. The device according to claim 6, wherein the processor is further configured to determine a transmission coefficient between two adjacent VSP channels by:
determining a value range of the quality factor;
acquiring, by way of scanning the quality factor within the value range, the quality factor which allows the objective function to have a minimum matching error; and
taking the quality factor corresponding to the objective function with the minimum matching error as an estimated quality factor.

9. The device according to claim 6, wherein the objective function is:
$$G ( {Q}_{k} , {C}_{k} ) = {\sum }_{f = {f}_{1}}^{{f}_{2}} {[ {S}_{k} ( f ) - {C}_{k} {S}_{k - 1} ( f ) exp ( \frac{- π {t}_{k}}{{Q}_{k}} f ) ]}^{2}$$
where f₁ represents a lower frequency limit of a predominant frequency band, f₂ represents an upper frequency limit of the predominant frequency band, Sₖ(f) represents an amplitude spectrum of a seismic wave of k^{th} VSP channel, Sₖ₋₁(f) represents an amplitude spectrum of a seismic wave of (k-1)^{th} VSP channel, tₖ represents a propagation time of a seismic wave between k^{th} and (k-1)^{th} VSP channels, Cₖ represents the indeterminate coefficient, Qₖ represents the quality factor between (k-1)^{th} and k^{th} VSP channels, and G represents a matching error.

10. The device according to claim 6, wherein the processor is further configured to determine a transmission coefficient between two adjacent VSP channels by:
performing a geometric diffusion compensation and a wave field separation for the zero offset VSP data to obtain a down-going wave field; and
determining the transmission coefficient between the two adjacent VSP channels according to the interval velocity of the seismic wave in the down-going wave field.
